(19) United States
(12) Patent Application Publication
(10) Pub. No.: US 2010/0276636 A1
(43) Pub. Date: Nov. 4, 2010

(54) PROCESS FOR THE PREPARATION OF BRIGHTENER PIGMENTS

(76) Inventors: Robert Hochberg, Merzhausen (DE); Oliver Becherer, Schworstadt (DE); Gerhard Merkle, Freiburg (DE)

Correspondence Address: BASF Corporation;Patent Department, 500 White Plains Road, P.O. Box 2005, Tarrytown, NY, 10591, US

(21) Appl. No.: 12/837,581

(22) Filed: Jul. 16, 2010

Related U.S. Application Data
(63) Continuation of application No. 10/592,236, filed on Sep. 7, 2006.

(30) Foreign Application Priority Data
Mar. 12, 2004 (EP) 04101017.4

(51) Int. Cl. C09K 11/06

(52) U.S. Cl. 252/301.23; 252/301.21

(57) ABSTRACT

Process for the preparation of a brightener pigment comprising
(a) a water-insoluble urea-formaldehyde resin having a water content of more than or equal to 50% by weight, and
(b) a water-soluble fluorescent whitening agent,
which process comprises
adding together (a), (b) and an inorganic salt, the amount of the inorganic salt being sufficient to effect deposition of the water-soluble fluorescent whitening agent (b) on the water-insoluble urea-formaldehyde resin (a).

This application is a continuation of co-pending application Ser. No. 10/592,236, filed on Sep. 7, 2006 which is the National Stage of International Application PCT/EP05/50903, filed Mar. 2, 2005, the contents of which are herein incorporated by reference.

The present invention relates to a process for the preparation of a brightener pigment comprising

(a) a water-insoluble urea-formaldehyde resin having a water content of more than or equal to 50% by weight, and
(b) a water-soluble fluorescent whitening agent,
which process comprises
adding together (a), (b) and an inorganic salt, the amount of the inorganic salt being sufficient to effect deposition of the water-soluble fluorescent whitening agent (b) on the water-insoluble urea-formaldehyde resin (a).

Preferably, there is used in accordance with the invention a water-insoluble urea-formaldehyde resin of which the molar ratio of urea to formaldehyde is from 1:1.3 to 2 moles.

The urea-formaldehyde resin is also distinguished by a small particle diameter of from 0.01 to 100 μm, especially 0.01 to 50 μm. Highly preferred is a particle diameter of from 0.01 to 20 μm, especially 0.01 to 10 μm.

In general, the BET specific surface area of the urea-formaldehyde resin is of from 2 to 200 m²/g, especially 5 to 120 m²/g. Highly preferred is a BET specific surface area of from 5 to 50 m²/g.

The BET specific surface area of the preferred water-insoluble urea-formaldehyde resins is ascertained according to the Brunauer, Emmett and Teller method [cf. J. Am. Chem. Soc. 60, 309-319 (1938), Chemie-Ing. Techn. 32, 349-354 (1960) and 35, 568-589 (1963)] according to DIN 66132.

The water-insoluble urea-formaldehyde resins, which correspond to component (a), and the preparation of those polymers, are known, for example, from A. Renner: Makromolekulare Chemie 149, 1-27 (1971).

The component (a) compounds are prepared by reacting formaldehyde with urea in aqueous solution in the above-described ratios. The reaction is carried out preferably in two steps. In the first reaction step, urea is reacted with formaldehyde according to a customary condensation mechanism, resulting in a low-molecular-weight, water-soluble pre-condensate. In the second reaction step, an acid catalyst can be used in order to accelerate the reaction and for crosslinking, an insoluble, finely divided solid being obtained.

The water content of the reaction solution should never be lower than the total weight of the reactants present in the reaction mixture, and should preferably be higher than the total weight of all the other components in the reaction mixture during the precipitation of the insoluble polymer particles.

The reaction temperature in the first reaction step is usually in the range from 20 to 100° C. The pH can be adjusted to from 6 to 9 by the addition of a strong, aqueous, inorganic base, such as, for example, sodium hydroxide solution.

Advantageously, the preparation of the pre-condensate can be carried out in the presence of a surfactant. The surfactant is used, for example, in amounts of from 0.5 to 5% by weight, based on the total weight of the urea and formaldehyde. Ionic surfactants cause an increase in the specific surface area of the urea-formaldehyde polymer product, whereas non-ionic surfactants have the opposite effect.

Advantageously, the first reaction step is carried out in the presence of a macromolecular water-soluble protective colloid having polyelectrolytic properties. Examples of such protective colloids include gelatin, tragacanth, agar and polyvinylpyrrolidone, especially methacrylic acid. The amount of protective colloid used can be within a range of, for example, from 0.5 to 5% by weight, based on the total weight of urea and formaldehyde. Neither polyvinylpyrrolidone nor polymethacrylic acid causes an increase in the specific surface area of the water-insoluble urea-formaldehyde resin.

One of the most important conditions for the successful preparation of non-meltable, insoluble and finely divided urea-formaldehyde polymers that meet the qualitative requirements of the brightener pigments in accordance with the invention is the use in the second reaction step of a suitable catalyst for gel formation. Suitable catalysts include, for example, relatively strong inorganic and/or organic acids, such as, for example, sulfuric acid, sulfurous acid, sulfamic acid, phosphoric acid, hydrochloric acid, chloroacetic acid, maleic acid or maleic anhydride. Generally, such gel-formation catalysts should have an ionisation constant in excess of 10⁻⁴. Sulfuric acid and its acidic ammonium or amine salts, and also ammonium sulfate, methylamine hydrogen sulfate and ethanolamine hydrogen sulfate, are preferred. The acids are generally used in the form of 1 to 15% by weight aqueous solutions. As a rough guide, from 20 to 100 mmoles of a crosslinking catalyst are used per mole of urea added. This causes a reduction in the pH of the reaction mixture to from 1 to 3.0 in the second reaction step during the formation of the polymer.

When sulfamic acid is used, water-insoluble urea-formaldehyde resins having a relatively high specific surface area are generally obtained, the other acids of those mentioned above, especially sulfuric acid and its ammonium or amine salts, having the opposite effect.

The reaction temperatures in the second, resin-forming reaction step usually reach from 20 to 100° C. Large differences in temperature in the reaction mixture should be avoided during the addition of the catalyst. It is therefore desirable to heat the aqueous catalyst solution to the temperature of the reaction mixture before it is added to that mixture. Generally, a white gel is obtained after only from 15 to 30 seconds. The crosslinking reaction is usually finished after a reaction time of from 30 minutes to 3 hours.

The insoluble polymer is obtained in the form of a white gel and can be comminuted mechanically, treated with a desired amount of water, adjusted with alkali or ammonium hydroxide to a pH of from 6 to 9, and then isolated from the aqueous phase, for example by filtration, centrifugation or concentration by evaporation. If desired, drying can be carried out e.g. by spray-drying or convection-drying, to prepare corresponding polymers having a specified water content.

The gel obtained is then worked up in customary manner, for example by allowing the reaction to proceed to completion, neutralising, and then filtering, washing, drying and, if desired, grinding to obtain a suitable particle size.

The water content of the water-insoluble urea-formaldehyde resin is preferably 50 to 90% by weight, especially 60 to 90% by weight. Highly preferred is a water content of 60 to 80% by weight. An example of such resins is Pergopak® HP. In the following, the weight of the urea-formaldehyde resin is to be understood to include the weight of water.

The ratio by weight of fluorescent whitening agent to urea-formaldehyde resin is typically 1:1000 to 1:10, especially 1:500 to 1:10. Highly preferred is a weight ratio of 1:250 to 1:50, especially 1:200 to 1:100.

Typical concentrations of the urea-formaldehyde resins used in the preparation process are 1 to 600 g/l, especially 10 to 600 g/l. Highly preferred concentrations of the urea-formaldehyde resins are 100 to 600 g/l, especially 200 to 600 g/l.

Preferred fluorescent whitening agents corresponding to component (b) that can be used in accordance with the invention correspond to formula

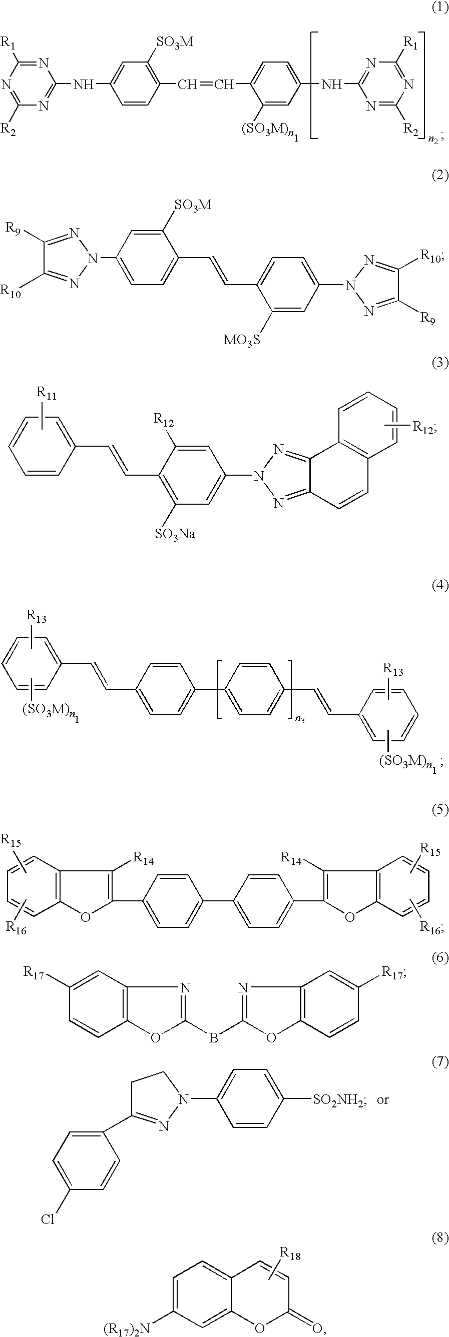

in which formulae
each R₁ is independently from each other a radical of formula

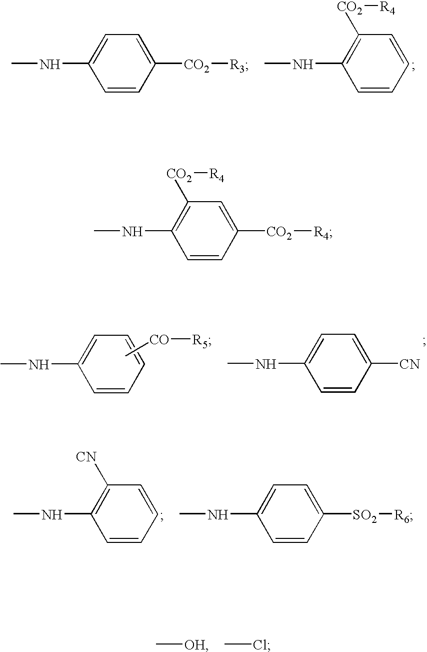

—NH₂; —O—C₁-C₄alkyl; —O-aryl; —NH—C₁-C₄alkyl; —N(C₁-C₄alkyl)₂;
—N(C₁-C₄alkyl)(C₁-C₄hydroxyalkyl); —N(C₁-C₄hydroxyalkyl)₂; —NH-aryl; morpholino or —S—C₁-C₄alkyl(aryl);
each R₂ is independently from each other hydrogen; an unsubstituted or substituted alkyl or aryl group; a radical of formula

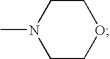

### —OH; —NH₂; —N(CH₂CH₂OH)₂;

—N[CH₂CH(OH)CH₃]₂; —NH—R₄; —N(R₄)₂; —OR₄; —Cl; —O—C₁-C₄alkyl; —O-aryl;
—NH—C₁-C₄alkyl; —N(C₁-C₄alkyl)₂; —N(C₁-C₄alkyl)(C₁-C₄hydroxyalkyl);
—N(C₁-C₄hydroxyalkyl)₂; —NH-aryl, or —S—C₁-C₄alkyl(aryl);
R₃ is an unsubstituted or substituted alkyl or aryl group;
each R₄ is independently from each other M, or an unsubstituted or substituted alkyl or aryl group;
R₅ is hydrogen; an unsubstituted or substituted alkyl or aryl group; or —NR₇R₈,
   wherein R₇ and R₈ are each independently of the other hydrogen or an unsubstituted or substituted alkyl or aryl group, or R₇ and R₈ together with the nitrogen atom linking them form a heterocyclic radical, especially a morpholino or piperidino radical;
R₆ is hydrogen, or an unsubstituted or substituted alkyl or aryl group;
R₉ and R₁₀ are each independently of the other hydrogen, C₁-C₄alkyl, phenyl or a radical of formula

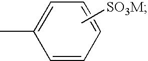

R₁₁ is hydrogen, —C₁ or SO₃M;
each R₁₂ is independently from each other —CN; —SO₃M; —S(C₁-C₄alkyl)₂ or —S(aryl)₂;
each R₁₃ is independently from each other hydrogen; —SO₃M; —O—C₁-C₄alkyl; —CN; —Cl; —COO—C₁-C₄alkyl or —CON(C₁-C₄alkyl)₂;
each R₁₄ is independently from each other hydrogen; —C₁-C₄alkyl; —Cl or —SO₃M;
R₁₅ and R₁₆ are each independently of the other hydrogen, C₁-C₄alkyl; —SO₃M; —Cl or —O—C₁-C₄alkyl;
each R₁₇ is independently of the other hydrogen or C₁-C₄alkyl;
R₁₈ is hydrogen, C₁-C₄alkyl; —CN; —Cl; —COO—C₁-C₄alkyl; —CON(C₁-C₄alkyl)₂; aryl or —O-aryl;

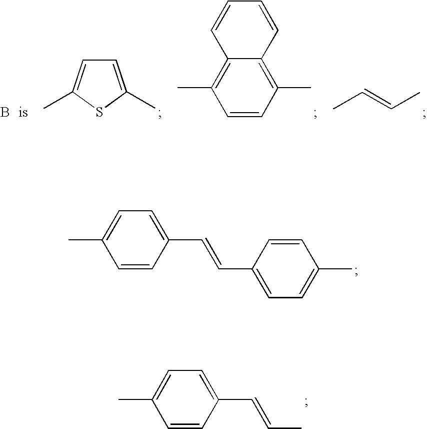

M is hydrogen; sodium; potassium; calcium; magnesium; ammonium; mono-, di-, tri- or tetra-C₁-C₄alkylammonium; mono-, di- or tri-C₁-C₄hydroxyalkylammonium; or ammonium di- or tri-substituted by a mixture of C₁-C₄alkyl and C₁-C₄hydroxyalkyl groups; and
n₁, n₂ and n₃ are each independently of the others 0 or 1.

R₂, R₃, R₄, R₅, R₆, R₇ and R₈ representing (unsubstituted or) substituted alkyl are each C₁-C₁₂alkyl, preferably C₁-C₄alkyl. The alkyl groups may be branched or unbranched and may be unsubstituted or substituted by halogen, e.g. fluorine, chlorine or bromine, by C₁-C₄alkoxy, e.g. methoxy or ethoxy, by phenyl or carboxyl, by C₁-C₄alkoxycarbonyl, e.g. acetyl, by mono- or di-C₁-C₄alkylamino or by —SO₃M.

R₂, R₃, R₄, R₅, R₆, R₇ and R₈ representing (unsubstituted or) substituted aryl are each preferably a phenyl or naphthyl group that may be unsubstituted or substituted by C₁-C₄alkyl, e.g. methyl, ethyl, propyl, isopropyl, butyl, isobutyl, sec-butyl or tert-butyl, by C₁-C₄alkoxy, e.g. methoxy, ethoxy, propoxy, isopropoxy, butoxy, isobutoxy, sec-butoxy or tert-butoxy, by halogen, e.g. fluorine, chlorine or bromine, by C₂-C₅alkanoylamino, e.g. acetylamino, propionylamino or butyrylamino, by nitro, by sulfo or by di-C₁-C₄alkylated amino.

The compounds of formula (I) are used preferably in neutral form, that is to say:

M is preferably a cation of an alkali metal, especially sodium, or is an amine.

The fluorescent whitening agents that can be used advantageously in the present invention are listed by way of example in the following Table 1:

TABLE 1

| Compound | |
|---|---|
| of formula | |
| (9) | 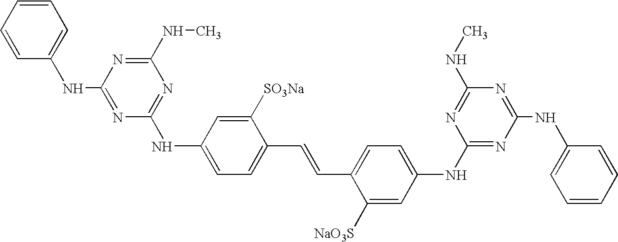 |
| (10) | 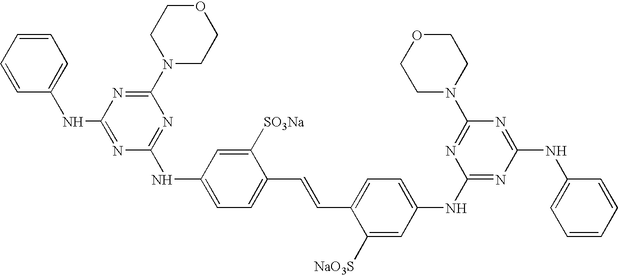 |
| (11) | 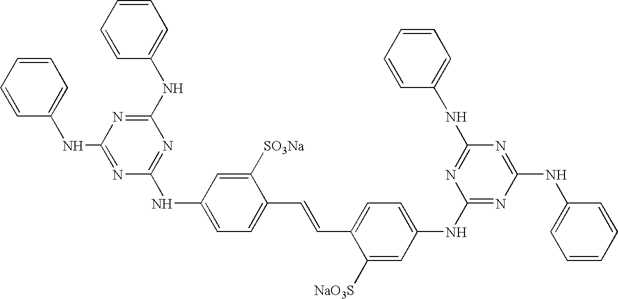 |
| (12) | 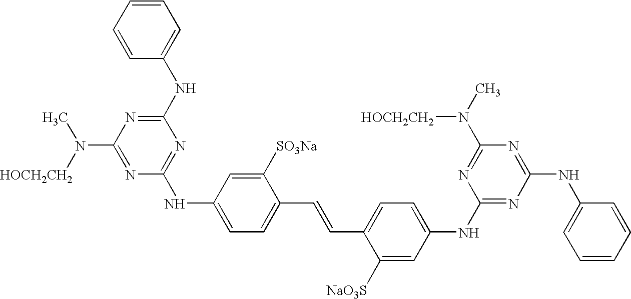 |
| (13) | 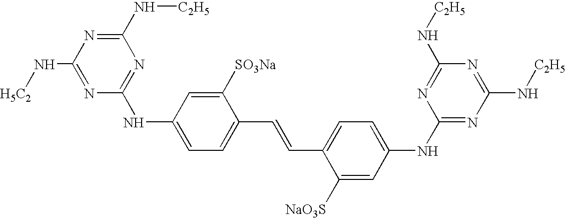 |
| (14) | 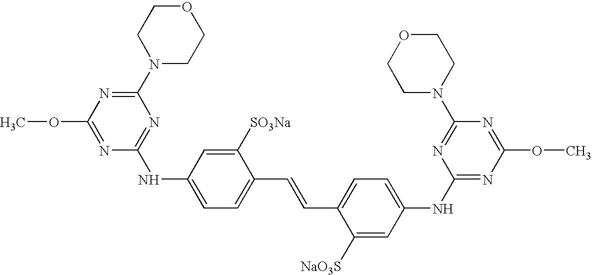 |
| (15) | 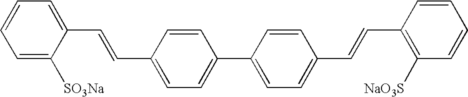 |
| (16) | 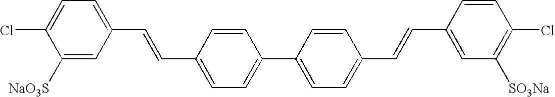 |
| (17) | 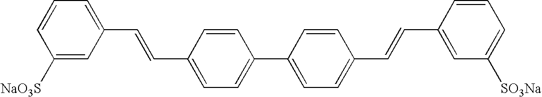 |
| (18) | 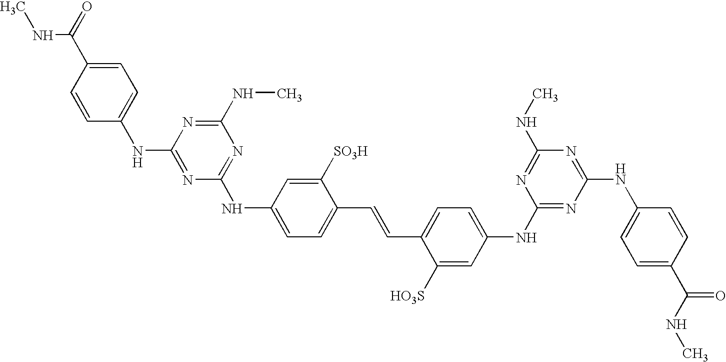 |
| (19) | 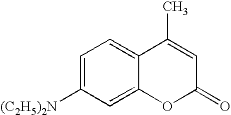 |
| (20) | 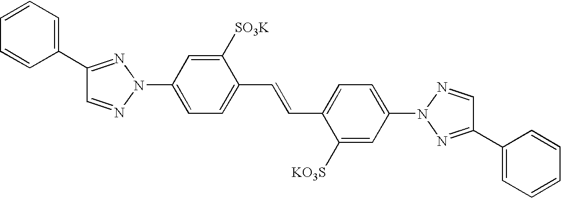 |
| (21) | 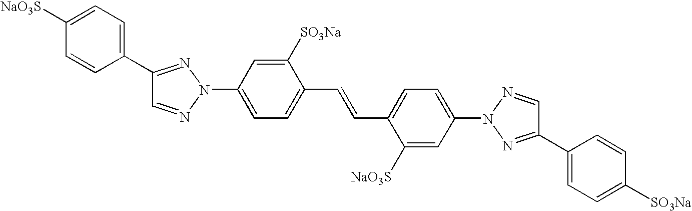 |
| (22) | 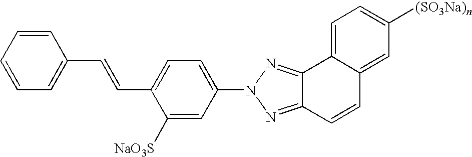 |
| (23) | 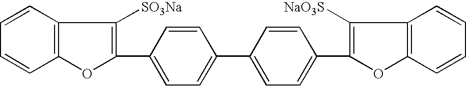 |
| (24) | 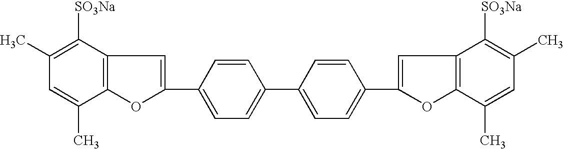 |
| (25) | 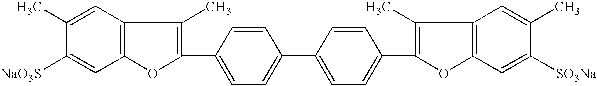 |
| (26) | 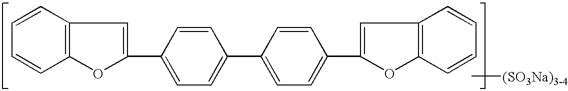 |

The fluorescent whitening agents corresponding to component (b) are employed preferably in amounts of from 0.001 to 10% by weight, especially from 0.1 to 10% by weight, and more especially from 0.1 to 5% by weight, based on the total amount of urea-formaldehyde resin. Highly preferred is an amount of 0.5 to 5% by weight. The fluorescent whitening agents can be added to the urea-formaldehyde resin in the form of individual compounds or in the form of mixtures of several individual compounds.

It is preferred for the process of the present invention to add the fluorescent whitening agent in the form of an aqueous solution. For such solutions an amount of 0.01 to 20% by weight of the fluorescent whitening agent, especially 0.1 to 10% by weight, is preferred. Highly preferred is an amount of 0.5 to 10% by weight.

Due to the use of an inorganic salt the fluorescent whitening agent can effectively be deposited on the urea-formaldehyde resin. This also enables the preparation of brightener pigments having high concentrations of fluorescent whitening agents.

Preferred inorganic salts are alkali or earth alkali salts, especially chlorides or sulfates. Examples of such salts are sodium chloride, sodium sulfate and calcium chloride, especially sodium sulfate and calcium chloride.

The ratio by weight of inorganic salts to urea-formaldehyde resin is typically 1:500 to 1:1, especially 1:200 to 1:1. Highly preferred is a weight ratio of 1:50 to 1:1, especially 1:20 to 1:1.

Typical concentrations of the inorganic salts used in the preparation process are 1 to 200 g/l. Highly preferred concentrations of the inorganic salts are 10 to 200 g/l, especially 10 to 100 g/l.

The process is usually carried out in aqueous medium. According to a preferred embodiment of the present invention an aqueous suspension or solution is prepared, comprising the fluorescent whitening agent and the urea-formaldehyde resin, and an inorganic salt is added. It is preferred that the addition of the inorganic salt is carried out at elevated temperature, like 30 to 90° C., especially 40 to 90° C. Highly preferred are temperatures of 50 to 90° C., especially 60 to 90° C.

Preferably, the water-soluble fluorescent whitening agent is added before, during or after gelation. Usually, the procedure comprises dispersing the urea-formaldehyde resin in hot water with a vigorous stirring action. If desired, the pH is adjusted to <10 using an aqueous alkali metal hydroxide solution and the water-soluble fluorescent whitening agent is added thereto. However, in general no adjustment of the pH is required. The batch is further stirred for some time and cooled. According to a less preferred variant the pH can be adjusted to <3 using a strong acid, especially sulfuric acid. A viscous suspension is obtained which is isolated by customary methods, such as filtration. If desired, the brightener pigment obtained can be further processed by drying and, optionally, by grinding.

According to a preferred embodiment of the present invention the brightener pigment is isolated, for example by filtration, and no separate drying or milling step is carried out. It is to be noted that the brightener pigments obtained according to the process of the present invention can be used without drying or grinding.

In a further embodiment, the brightener pigment may be subjected to a surface treatment. For that purpose, an emulsion of long-chain alcohols or derivatives thereof, of derivatives of ethylene oxide-alcohols, of paraffin waxes, or of hydrogenated natural or synthetic resins, etc., and especially a dodecanol emulsion, is added to the viscous urea-formaldehyde resin/whitening agent suspension. The batch is stirred for a further 10 to 15 minutes at elevated temperature. After cooling, the batch is filtered and, if desired, can be further processed as given above, yielding a surface-treated formaldehyde resin/whitening agent suspension. However, if desired, the extra step of surface treatment can be omitted.

Dazzlingly white organic brightener pigments are obtained which have a very low content of free formaldehyde (typically less than 0.1% DIN 58187) in which the fluorescent whitening agent has been incorporated or adsorbed. Such products are solid, colloidal particles. Particles of lower diameter can agglomerate to form pigment particles having an average diameter of from, for example, 3 to 20 μm.

Another object of the present invention are additives in the form of a brightener pigment comprising

a) a water-insoluble urea-formaldehyde resin having a water content of more than or equal to 50% by weight, and
(b) a water-soluble fluorescent whitening agent.

As to these additives the definitions and preferences given above apply.

The fluoresecently brightened pigments prepared in that manner are excellently suitable for improving the degree of whiteness (improvement in appearance) of commerically available detergents and cleansers, of compounds thereof, and of individual raw materials.

The brightener pigment used in accordance with the invention is usually incorporated into the detergents or cleansers by first suspending the brightener pigment in water, with stirring, and then adding the detergent or cleanser in question to the resulting suspension with the further addition of water. A creamy slurry is obtained, which is then dried and sieved to yield a detergent or cleanser having a particle size of approximately from >0.3 to 1 mm.

In a further embodiment, the fluorescently brightened detergent or cleanser, compounds thereof and individual raw materials are prepared by simply dusting with the brightener pigment in powder form. For that purpose from 0.5 to 20%, typically from 1 to 10%, of brightener pigment based on the component to be whitened is dry-mixed until the particles have been coated with the pigment.

Suitable compositions that can be treated in accordance with the invention with the brightener pigment comprising components (a) and (b) are detergents or cleansers in the form of powder or granules. Such formulations may be particulate detergents composed of one or more granular components in which at least one granular component is acted upon by the brightener pigment.

There come into consideration preferably formulations in granular form that have a high bulk density. In addition to the brightener pigment, the detergent may comprise further ingredients, e.g. surfactants, inorganic and organic builder substances, bleaching agents, substances that have a positive effect on the ability to wash out oil and grease, greying inhibitors, if desired substances that improve the solubility and the rate of dissolution of the individual granular components and/or of the entire formulations, fabric-softening substances, colorants and perfumes, and also alkaline and/or neutral salts in the form of their sodium and/or potassium salts.

In addition, washing-active or cleaning-active shaped forms, for example detergent tablets, dishwashing agent tablets, stain-removing salt tablets or water-softening tablets, can be provided in accordance with the invention.

The washing-active or cleaning-active shaped forms are especially cylindrical shapes or tablets that can be used as detergents, dishwashing agents, or bleaching agents (stain-removing salts), but can also be used as pretreatment agents, for example as water softeners or bleaching agents. A distinction is drawn between homogeneous (homo-geneously distributed ingredients) and heterogeneous (heterogenously distributed ingredients) shaped forms, which have as a special feature a disintegrator, such as, for example, starch, a starch derivative, cellulose or a cellulose derivative, which brings about the disintegration of the washing-active or cleaning-active shaped form. It is possible, in particular, for the degree of whiteness of such a disintegrator to be excellently improved by the brightener pigments used in accordance with the invention.

The so-treated detergent is distinguished by a very high degree of whiteness, which is substantially higher than that achieved by the discrete addition of organic white pigment and fluorescent whitening agent.

The following Examples illustrate the invention, without the invention being limited thereto.

### EXAMPLE 1

465 g demineralized water and 375 g of a commercially available urea formaldehyde condensation polymer (Pergopak HP) are filled into a 1.5 l vessel and heated to 65-70° C. After the addition of 2.5 g of the compound of formula (101)

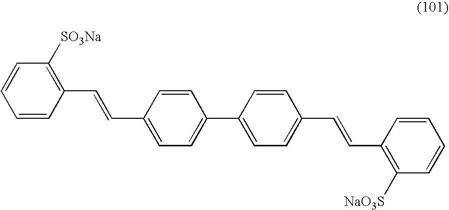

the suspension is stirred for 20 minutes at 65-70° C. Subsequently 48 g of sodium chloride are added and the mixture is stirred for another 30 minutes. To this suspension a warm emulsion (70° C.) is added that has been prepared separately from 1.2 g 1,2-dodecandiol and 240 g demineralized water. The mixture is stirred for 30 minutes, cooled to 35° C. and filtered. 452 g of a white wet cake are obtained.

### EXAMPLE 2

465 g demineralized water and 375 g of a commercially available urea formaldehyde condensation polymer (Pergopak HP) are filled into a 1.5 l vessel and heated to 65-70° C. After the addition of 2.5 g of the compound of formula (101) the suspension is stirred for 20 minutes at 65-70° C. Subsequently 48 g of sodium chloride are added and the mixture is stirred for another 30 minutes. Then the mixture is cooled to 35-38° C. by addition of 290 g crushed ice and filtered. 458 g of a white wet cake are obtained.

### EXAMPLE 3

465 g demineralized water and 375 g of a commercially available urea formaldehyde condensation polymer (Pergopak HP) are filled into a 1.5 l vessel and heated to 65-70° C. After the addition of 2.5 g of the compound of formula (101) the suspension is stirred for 20 minutes at 65-70° C. Subsequently 48 g of sodium sulfate are added and the mixture is stirred for another 30 minutes. To this suspension a warm emulsion (70° C.) is added that has been prepared separately from 1.2 g 1,2-dodecandiol and 240 g demineralized water. The mixture is stirred for 30 minutes, cooled to 35° C. and filtered. 449 g of a white wet cake are obtained.

### EXAMPLE 4

465 g demineralized water and 375 g of a commercially available urea formaldehyde condensation polymer (Pergopak HP) are filled into a 1.5 l vessel and heated to 65-70° C. After the addition of 2.5 g of the compound of formula (101) the suspension is stirred for 20 minutes at 65-70° C. Subsequently 48 g of sodium sulfate are added and the mixture is stirred for another 30 minutes. Then the mixture is cooled to 35-38° C. by addition of 290 g crushed ice and filtered. 445 g of a white wet cake are obtained.

### EXAMPLE 5

465 g demineralized water and 375 g of a commercially available urea formaldehyde condensation polymer (Pergopak HP) are filled into a 1.5 l vessel and heated to 65-70° C. After the addition of 2.5 g of the compound of formula (101) the suspension is stirred for 20 minutes at 65-70° C. Subsequently 3 g of calcium chloride×2H₂O are added and the mixture is stirred for another 30 minutes. To this suspension a warm emulsion (70° C.) is added that has been prepared separately from 1.2 g 1,2-dodecandiol and 240 g demineralized water. The mixture is stirred for 30 minutes, cooled to 35° C. and filtered. 403 g of a white wet cake are obtained.

### EXAMPLE 6

465 g demineralized water and 375 g of a commercially available urea formaldehyde condensation polymer (Pergopak HP) are filled into a 1.5 l vessel and heated to 65-70° C. After the addition of 2.5 g of the compound of formula (101) the suspension is stirred for 20 minutes at 65-70° C. Subsequently 3 g calcium chloride×2H₂O are added and the mixture is stirred for another 30 minutes. Then the mixture is cooled to 35-38° C. by addition of 290 g crushed ice and filtered. 396 g of a white wet cake are obtained.

What is claimed is:

1. A process for the preparation of a brightener pigment comprising
(a) a water-insoluble urea-formaldehyde resin having a water content of more than or equal to 50% by weight, and
(b) a water-soluble fluorescent whitening agent,
which process comprises
adding together (a), (b) and an inorganic salt, the amount of the inorganic salt being sufficient to effect deposition of the water-soluble fluorescent whitening agent (b) on the water-insoluble urea-formaldehyde resin (a) and
wherein the inorganic salt is sodium sulfate or calcium chloride and the fluorescent whitening agent is of formula (4) 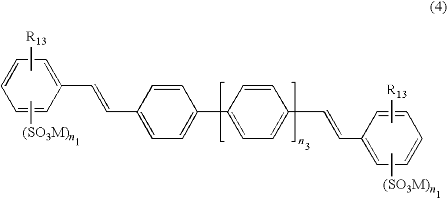
each R₁₃ is independently from each other hydrogen; —SO₃M; —O—C₁-C₄alkyl; —CN; —Cl; —COO—C₁-C₄alkyl or —CON(C₁-C₄alkyl)₂;
M is hydrogen; sodium; potassium; calcium; magnesium; ammonium; mono-, di-, tri- or tetra-C₁-C₄alkylammonium; mono-, di- or tri-C₁-C₄hydroxyalkylammonium; or
ammonium
di- or tri-substituted by a mixture of C₁-C₄alkyl and C₁-C₄hydroxyalkyl groups; and
n₁ and n₃ are each independently of the other 0 or 1.

2. A process according to claim 1, wherein the water content of the water-insoluble urea-formaldehyde resin is 50 to 90% by weight.

3. A process according to claim 1, wherein the water content of the water-insoluble urea-formaldehyde resin is 60 to 90% by weight.

4. A process according to claim 1, wherein the water-insoluble urea-formaldehyde resin has a molar ratio of urea to formaldehyde of from 1:1.3 to 2 moles, a particle diameter of from 0.01 to 100 μm and a BET specific surface area of from 2 to 200 m²/g.

5. A process according to claim 1, wherein the ratio by weight of inorganic salts to urea-formaldehyde resin is 1:500 to 1:1.

6. A process according to claim 1, wherein the urea-formaldehyde/fluorescent whitening agent suspension is subsequently treated with an emulsion of long-chain alcohols or derivatives thereof, of derivatives of ethylene oxide-alcohols, of paraffin waxes, or of hydrogenated natural or synthetic resins.

7. A process according to claim 1, wherein the brightener pigment is isolated by filtration and no separate drying or milling step is carried out.
